(19) United States
(12) Patent Application Publication
(10) Pub. No.: US 2012/0311853 A1
(43) Pub. Date: Dec. 13, 2012

(54) Extraction System for a Mineral Cutter Pick

(75) Inventor: George Albert Parrott, Wakefield (GB)

(73) Assignee: Minnovation Limited, Wakefield (GB)

(21) Appl. No.: 13/580,174

(22) PCT Filed: Feb. 3, 2011
(86) PCT No.: PCT/GB2011/000136

§ 371 Date: Aug. 21, 2012

(30) Foreign Application Priority Data
Feb. 22, 2010 (GB) 1002949.4
Jul. 7, 2010 (GB) 1011427.0

(51) Int. Cl. B23P 19/00

(52) U.S. Cl. 29/700

(57) ABSTRACT

A system for extraction of a mineral cutter pick (1), and optionally any interposed sleeve (19), the pick (1) comprises an elongate shank (4) extending from an enlarged head (2), has a piston (12) coaxial with the shank (4), with one end face (16) of the piston (12) subjectable to hydraulic pressure fluid, and with another, opposite end face (15) of the piston (12) capable of engaging an end face (5) of the shank (4), a sealing ring (14) to prevent passage of hydraulic fluid being carried by the piston (12), whereby axial movement of the piston (12), under hydraulic pressure, in turn axially displaces the pick (1), whilst further movement of the piston (12) results in extraction, if required, of sleeve (19).

### FIELD OF THE INVENTION

This invention relates to an extraction system for a mineral cutter pick and, optionally, any sleeve interposed between a shank of the pick and a receiving bore of a pick box (also known as a block) in which the pick is releasably retained. Mineral cutter picks are used extensively in mining of minerals such as coal, in the driving of underground roadways or tunnels, and in the planing of asphalt or concrete road surfaces as part of road surface renewal.

### BACKGROUND OF THE INVENTION

Rotary cutting heads of mining machines or machines for the driving of underground roadways or tunnels, are conventionally provided with a plurality e.g. 50-150 blocks welded in place, each to receive a replaceable cutter pick provided with a carbide tip, each block having a receiving bore to receive a close fitting shank of the pick either directly, or more usually with an interposed sleeve.

Pick replacement is normally required after a certain degree of wear, loss of a tip, or pick breakage, and has usually required manual removal e.g. by the use of a chisel, drift, hammer etc with risk not only of sparks but also of flying metal particles, requiring variable degree of manual force. However, for various reasons, some picks may be impossible to remove manually and can only be removed after removing the entire sleeve or, in some cases, the block. This may mean removal of the rotary cutting head from its machine for transport to the surface of a coal mine, or to a safe area, where burning and welding operation can be carried out.

In the planing of road surfaces in preparation for re-surfacing operations, rotary cutting drums of road surface planing machines are conventionally provided with possibly 150 blocks, each to receive a replaceable cutter pick provided with a carbide tip, each pick box having a receiving aperture to receive a wear sleeve, with a shank of the pick engaged in the sleeve.

The need to accommodate a relatively large number of picks around the external periphery of the drum of a road planing machine, constrains the size of pick that can be used, and typical road planing picks have shanks of say 20 mm or ½ inch diameter. The result is the inevitable breakage of a large number of picks and the consequent need to remove the remains of a broken pick from the receiving bore of a block in which aperture the shank is located, usually with an interposed wear sleeve. Even if breakage has not occurred, regular pick replacement is required to counter the effects of wear and/or loss of a carbide tip.

In one known mechanical removal system an operative engages in a drift, against an end face of the shank of the pick, to push or prise the shank from the sleeve, or hammers a wedge against the end face.

Another current mechanical system for pick extraction, but which is in extensive use, employs a two pronged fork with wedge tines, which tines are hammered by an operative under a collar of the pick specifically provided for extraction purposes. These extraction procedures might need to be repeated 100 times or more depending on the nature of the cutting drum and the number of blocks welded, in predetermined array, around its external periphery.

In EP 1064453 is a proposal for hydraulic extraction of the shank of a pick holder located in a blind bore, whereby the shank of a pick holder is provided with a sealing ring to seal against the shank-receiving bore of the block, and hydraulic pressure is applied to the end face of the shank. In this system, the end of the pick is exposed and so can be knocked out by a hammer, and/or a drift can be engaged with a groove in the pick head.

However, in extensive use is a sleeved system as shown in GB 2285464, and here the means of achieving sleeve extraction (the pick can again be removed manually) is to step the sleeve, to provide sealing rings at either side of the step, and to introduce hydraulic fluid to the zone between the sealing rings. Whilst this system provides a solution for sleeve extraction, manual pick extraction can still be problematical and/or hazardous.

Both the above proposals for hydraulic extraction, whilst achieving the desired results, require modification from industry standard, of sleeve and/or block.

Furthermore, it will be appreciated that whilst the majority of picks can be successfully removed with a lever or wedge, inevitably with an unfavourable combination of manufacturing tolerances of a shank diameter etc plus the impacts received by the pick in service, it may prove impossible to extract a seized or broken pick manually from its sleeve.

### OBJECT OF THE INVENTION

A basic object of the invention is the provision of a system for hydraulic extraction of:—

(i) a pick from a receiving bore of a block, in a non-sleeved system;
(ii) a pick from a receiving bore of a sleeve, in a sleeved system, and also when required the sleeve from the receiving bore of a block;
(iii) a sleeve and a seized or broken pick as a unit, from a block of a sleeved system.

### Summary of a First Aspect of the Invention (Non-Sleeved)

According to a first aspect of the invention, there is provided a system for extraction of a mineral cutter pick, comprising an elongate shank extending from an enlarged head, from a receiving bore in which the shank is releasably fitted, characterised in that a piston coaxial with the shank is provided, with one end face of the piston subjectable to hydraulic pressure fluid, and with another, opposite end face of the piston capable of engaging an end face of the shank, and with a sealing ring to prevent passage of hydraulic fluid carried by the piston, whereby axial movement of the piston, under hydraulic pressure, in turn axially displaces the pick along the bore for extraction purposes.

### Summary of a Second Aspect of the Invention (Sleeved)

According to a second aspect of the invention, there is provided a system for extraction of a mineral cutter pick and, if required, a sleeve, the latter comprising an enlarged head from one side of which extends a tubular body portion, has the tubular body portion located in a receiving bore of a block and the pick shank located in a receiving bore of the elongated body portion, characterised in that a headed piston coaxial with both the shank and the sleeve is provided, with one end face of the head of the piston subjectable to hydraulic pressure fluid, and another, opposite end face of the piston engageable with an end face of the pick shank, both the piston and sleeve carrying sealing rings to prevent passage of hydraulic fluid, whereby axial movement of the piston, under hydraulic pressure, in turn axially displaces the pick with respect to the sleeve, until the piston head eventually engages the sleeve with, if required, continued admission of pressure fluid causing displacement of the sleeve axially with respect to the block.

### ADVANTAGES OF THE INVENTION

The two aspects of the invention enable an unmodified, industry-standard pick to be extracted from a receiving bore, and furthermore, in the event that an interposed sleeve is present, similarly enables sleeve extraction from a receiving bore.

It will be appreciated that sleeve extraction (for replacement) is a relatively rare requirement compared with pick replacement, and would only be necessary if the sleeve, and in particular its enlarged head, had been allowed to become worn or damaged e.g. by a broken, or lost pick not being replaced in good time, or if a pick had become jammed, seized, rusted or broken such that the entire pick and sleeve as a unit needed to be extracted from the block, with a rusted-in sleeve being a particular problem, as coal mines in particular usually demand a “wet” system, with one or more water sprays being located in the vicinity of the pick, for a variety of well known reasons.

Clearly, a pressure fluid supply port needs to be connectable from a source of pressure fluid to deliver pressure fluid to the vicinity of the first end face of the piston.

In tests, it has been found that non-problem picks can be extracted with relative ease, at low pressures, of around 50 psi, whereas a fluid pressure e.g. of 4000-5000 psi might be required to extract a sleeve, or sleeve and pick as a unit.

It will also be apparent, that the piston diameter(s) need(s) to be so selected that with whatever hydraulic pressure is available (in a coal mine at least 5000 psi is normally available) this pressure should be sufficient to displace the pick, and if required the sleeve.

### Preferred or Optional Features

In the non-sleeved system, the bore is provided in a block. Consequently, the sealing ring carried by the piston engages the bore of the block. The bore is a blind bore.

The piston is not headed, but of constant diameter, save for a circumferential groove to house an elastomeric sealing ring.

In a first embodiment of a sleeved system, the tubular body portion is of extended length compared with an industry-standard sleeve, so that the piston can be housed wholly within the sleeve.

The tubular body portion comprises two coaxial, internal bores separated by an annular, internal collar of diameter corresponding to that of the piston, one bore being an outer bore adapted, in use, to releasably house a shank of a mineral cutter pick, and the other bore being an inner bore to house the piston.

The annular, internal collar is provided with a sealing ring slidably engageable with the external periphery of the portion of the piston passing through the collar:

The enlarged head of the piston also carries a sealing ring.

An additional sealing ring, to seal between the external periphery of the sleeve and the receiving bore of the block, is carried by a circumferential groove of the sleeve.

In a second embodiment of a sleeved system, the sleeve is not extended as in the first embodiment, but is of industry-standard length, the receiving bore of the block is extended such that the piston may be partially housed in the bore of the block, and partially in the bore of the tubular body portion of the sleeve.

The sleeve is stepped externally, and is provided with a first sealing ring adjacent its enlarged head, and a second sealing ring adjacent the end of the tubular body portion distal from the enlarged head.

The sleeve is also stepped internally as is the shank.

In a third embodiment of sleeved system suitable for road planing, the receiving bore of the block is a parallel sided through bore.

The through bore has an annular internal rib at a rear end against which is abutted a bore closure disc having a fluid flow bore extending to an external nipple, for attachment of for example a manually operable grease type gun, when hydraulic extraction is required, although, if required, as an alternative, a removable, screw-in, screw-out plug could be provided, the plug being removed for the attachment of a hydraulic hose fitting.

Instead of providing the nipple in a portion of the pick box, the closure disc may carry the nipple for both admittance and exhaust of hydraulic fluid.

The hydraulic hose fitting is of a snap-on, quick release type, avoiding the need to screw a coupling onto the nipple.

With a hand operable pump of the grease gun type used to supply hydraulic fluid via a flexible high pressure hose (readily available thermoplastic hose can accommodate 600 bars/8700 psi), to extraction of a pick, then provided the hydraulic pressure behind the piston is released, the pushing in of a new replacement pick in turn pushes the piston back to its start position, and return the oil to the tank/chamber, ready for re-use with the next extraction.

Alternatively, the nipple could be provided in a tapped hole of the block.

### BRIEF DESCRIPTION OF THE DRAWINGS

In the accompanying drawings,

FIGS. 1 and 2 show the extraction of a non-sleeved, coal etc cutter pick from a block;

FIGS. 3, 4 and 5 show a first embodiment of a sleeve system, also for a coal etc cutter pick;

FIGS. 6, 7 and 8 show a second embodiment of a sleeved system, also for a coal etc cutter pick; and

FIGS. 9, 10, 11 and 12 show a third embodiment of a sleeved system for road planing.

### DETAILED DESCRIPTION OF THE DRAWINGS

In all figures, like reference numerals are used for like components.

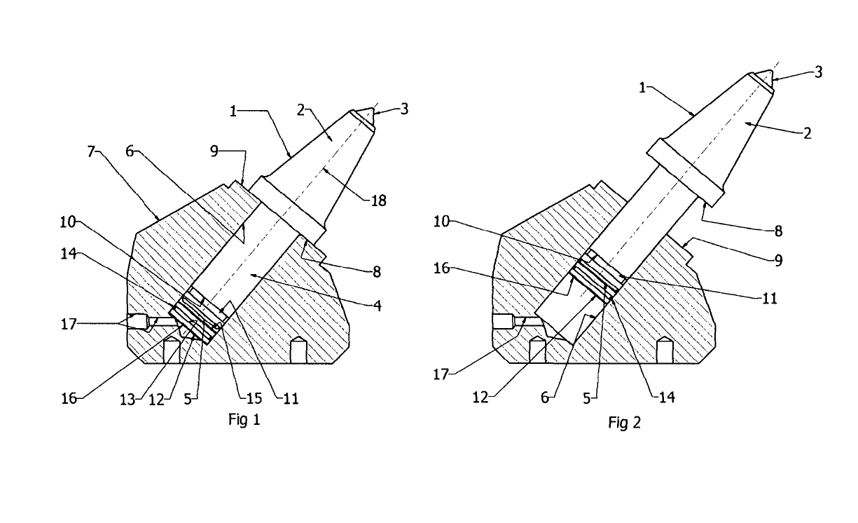

In FIGS. 1 and 2, a coal etc cutter pick 1 having an enlarged head 2 provided with a carbide tip 3, is secured by an integral, cylindrical shank 4, having an end face 5, in a blind receiving bore 6, of constant diameter, drilled into a block 7, which block is adapted to be secured, by welding, around the periphery of a drum or disc (not shown) of a mineral winning machine, a tunnel or roadway driving machine, or a road planing machine, the pick head 2 and specifically the carbide tip 3 impacting on the mineral etc involved.

When the pick 1 is fitted into the block 7 as illustrated in FIG. 1, an annular seating surface 8 of the enlarged head 2 engages a seating surface 9 provided by the block 7, whilst inadvertent loss of the pick 1 from the block 7 is resisted by providing a circumferential groove 10 in the shank 4, and locating a spring clip 11 in the groove 10 to make frictional engagement with the bore 6.

The length of the bore 6 exceeds that of the shank 4 so that a piston 12 may be coaxially located in the bore 6 beyond the end face 5 of the shank 4. The piston 12 has a circumferential groove 13 in which is located an elastomeric, fluid sealing ring 14 and opposed end faces 15 and 16, the face 15 being adapted to abut the end face 5 of the shank 4 when hydraulic fluid, supplied via a tapped port 17 in the block 7, is applied to the full area of the face 16. The port 17 is closed either by a screw-in plug, when hydraulic extraction is not required, or by a screw-in grease nipple, which could be left permanently in place. Pick changing is of course frequently required, typically on a daily or even every shift basis, to replace a worn or broken pick 1, necessitating the extraction of the pick 1 from its block 7. The problems of pick extraction have already been outlined.

In accordance with the invention, the pick 1, which has a longitudinal axis 18, is no longer extracted manually, but on the contrary is extracted by hydraulically displacing the piston 12 axially, which in turn axially displaces the pick 1 from the fully engaged position shown in FIG. 1, to a partially ejected position shown in FIG. 2, from which partially ejected position the pick 1 may be pulled, by hand, and a fresh pick inserted by hand. The piston 12 in effect pushes the pick 1 from the block 7. Furthermore, with the fluid pressure released, the pushing in of a fresh pick not only pushes the piston 12 back to the bottom of the bore 6 from the position illustrated in FIG. 2 to the position illustrated in FIG. 1, but also, advantageously, returns the pressure fluid (preferably a water/oil emulsion) to a reservoir.

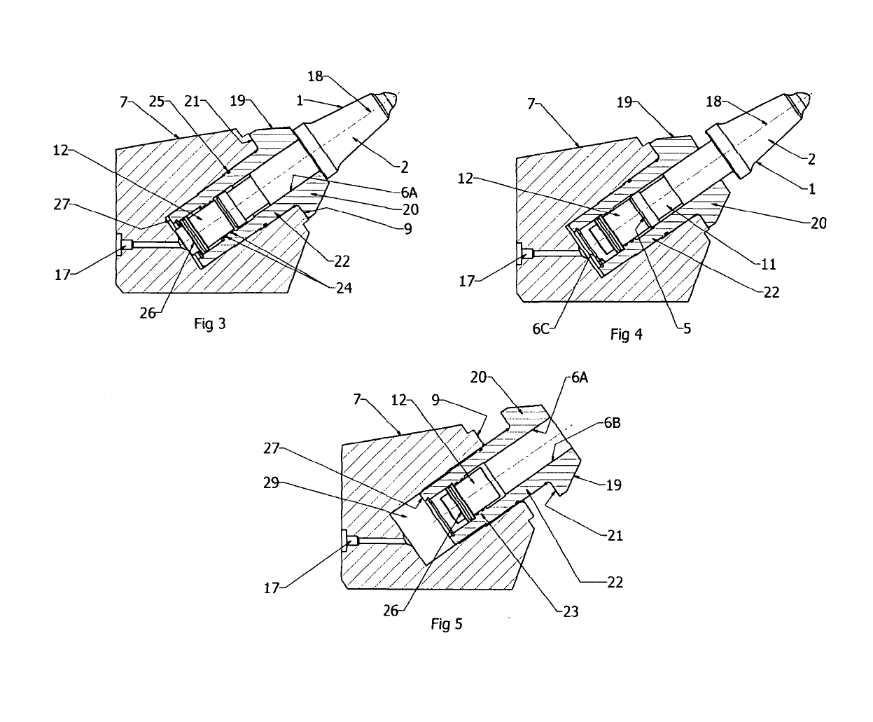

In FIGS. 3, 4 and 5 is illustrated a first embodiment of a sleeved system, whereby a sleeve 19 is interposed between the pick 1 and the block 7. Thus the sleeve 19 is located in the bore 6, and comprises an enlarged head 20 providing an annular seating surface 21 to bear on the seating surface 9 provided by the block 7, from which enlarged head 20 extends a tubular body portion 22 providing a bore 6A. The bore 6A is defined by two, coaxial bore parts, being an outer bore part 6B to house the shank 4 of a pick 1, and a coaxial inner bore part 6C to house the piston 12, the parts 6B and 6C being separated by an annular, internal collar 23 of diameter corresponding to that of a portion of the piston 12 that slidingly passes through the collar 23 and is provided with a fluid sealing rings 24 to engage the periphery of that portion of the piston 12. Multiple circumferential external grooves provided in the tubular body portion 22 of the sleeve 19 each retain an elastomeric, fluid sealing rings 25 adapted to make sliding, fluid sealing engagement, with the bore 6. Rings 25 at each end of the sleeve 19 seal the sliding contact area between the external periphery of the sleeve 19 and the receiving bore in the block 7, thus preventing any water entry so that the contact area remains rust free so minimizing the forces required to extract the sleeve 19 as the latter cannot become rusted-in.

The piston 12 has an enlarged head 26 located in the bore part 6C, whilst at its end distal from the head 26, the tubular body portion 22 of the sleeve 19 terminates in an annular end surface 27, in the vicinity of which a circlip 28 is located to ensure retention of the piston 12 within the bore part 6C.

Upon initial admission of hydraulic fluid via port 17 the piston 12 is axially displaced until the piston 12 eventually reaches the position shown in FIG. 4 in which the enlarged head 26 abuts the internal collar 23. Such displacement pushes the pick 1 partially out of the sleeve 19, and after such initial un-seating of the pick 1, the pick can be fully removed by hand, without difficulty, to be replaced by a fresh pick. As before, with the pressure released, the manual pushing in of a fresh pick returns the piston 12 to the position shown in FIG. 3, and returns the hydraulic fluid to a reservoir.

In less frequent circumstances where it is also required to replace a worn or broken sleeve 19, then from the position illustrated in FIG. 4, continued admission of pressure fluid to chamber 29, with the pressure fluid effective not only on the area of the enlarged head 26 of the piston 12, but also on the area of the annulus surface 27 of the sleeve 19, ejects the sleeve 19 from the bore 6, as shown in FIG. 5. Again, with this initial un-seating of the sleeve 19, the sleeve 19 can be fully removed by hand for replacement by a fresh sleeve.

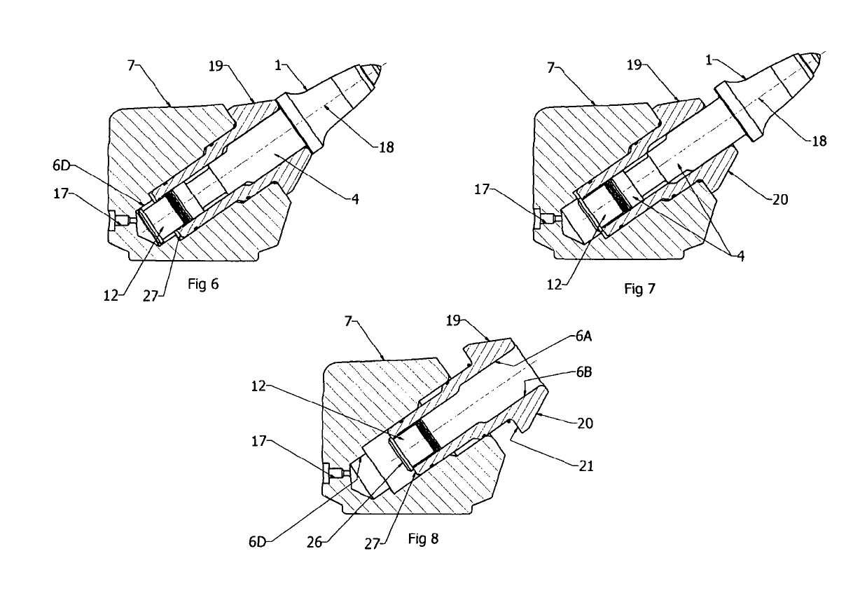

The embodiment of FIGS. 6-8 is also sleeved, similarly to that of FIGS. 3-5 except that the bore 6 is extended into bore part 6D to accommodate a portion of the piston 12, as the piston 12 is partially located within the bore part 6D and partially with the sleeve 19. But the principle of operation is the same, in that, upon first admission of pressure fluid via port 17, the piston 12 has no effect on the sleeve 19 but only displaces the pick 1 to the position illustrated in FIG. 7 when the enlarged head 26 of the piston 12 abuts the annular end surface 27 of the sleeve 19, whereupon should extraction of the sleeve 19 also be required, continued admission of pressure fluid would cause ejection of the sleeve 19 to the position illustrated in FIG. 8.

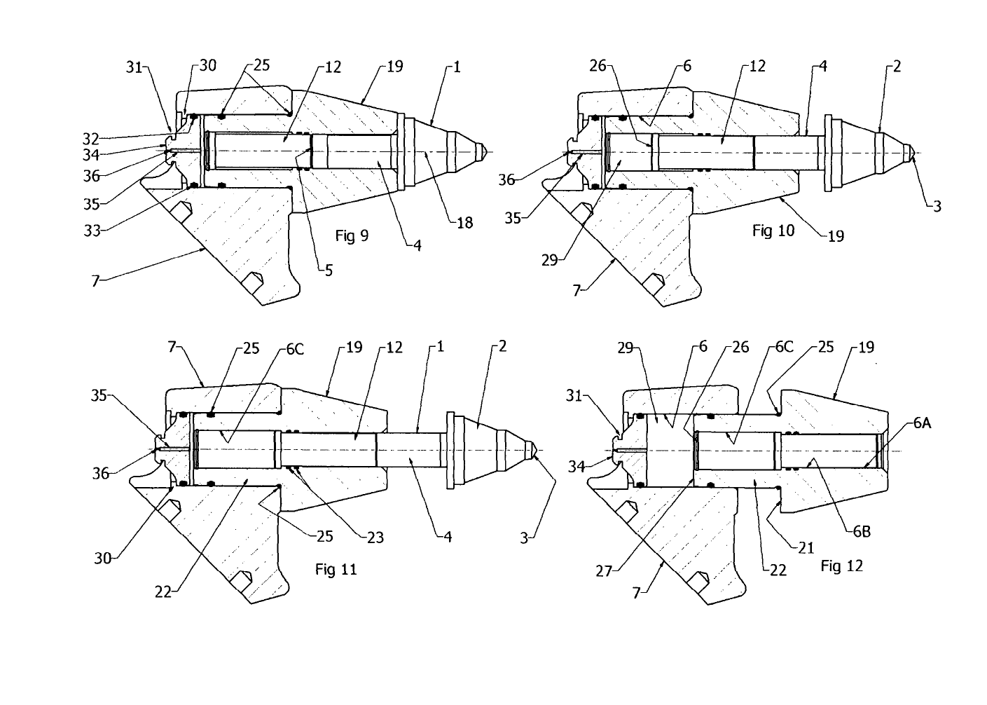

The embodiment of FIGS. 9-12 is again a sleeved system with the piston 12 wholly located within the sleeve 19, but the bore 6 is a through bore having an annular rib 30 at an end of the bore 6 distal from the seating surface 9. The end of the bore 6 adjacent the rib 30 is closed off by insertion of a plug 31 which abuts the rib 30 and has an annular groove 32 carrying a ring 33 which sealingly engages a portion of the bore 6, whilst a pressure fluid entry/exit nipple 34 is machined into an outer face of the plug 31. The plug 31 is provided with a first pressure fluid entry/exit port 35 and a second coaxial port 36 in the vicinity of the nipple 34, the port 36 being of minimal diameter to counter any propensity for blockage by dust/dirt particles.

From the “start” position illustrated in FIG. 9, admission of pressure fluid e.g. by manually attaching a horseshoe hose connector (not shown) to the nipple 34 to chamber 29 displaces the piston 12 axially, which in turn pushes the pick 1 from its fully seated position in FIG. 9 to its partially ejected position in FIG. 10, from where the pick can be manually removed with ease followed by insertion of a fresh pick. Again, if sleeve removal is required, then continued admission of pressure fluid to the chamber 29 unseats the sleeve 19 and pushes it from the position indicated in FIG. 11 to the ejected position indicated in FIG. 12, from which it can be readily removed, by hand.

1.-20. (canceled)

21. A system for extraction of a sleeved, mineral cutter pick (1) and, if required, also the sleeve (19) from a block (7), the sleeve (19) comprising an enlarged head (20), from one side of which extends a tubular body portion (22), has the tubular body portion (22) located in a receiving bore of the block (7) and a pick shank (4) located in a receiving bore (6) of the body portion (22), characterised in that a headed piston (12) coaxial with both the shank (11) and the sleeve (10) is provided, with one end face (16) of the head of the piston (12) subjectable to hydraulic pressure fluid, and another, opposite end face (15) of the piston (12) engageable with an end face (5) of the pick shank (4), both the piston (12) and sleeve (19) carrying sealing rings (14, 25) to prevent passage of hydraulic fluid, whereby axial movement of the piston (12), under hydraulic pressure, in turn axially displaces the pick (1) with respect to the sleeve (19), until the piston head (26) eventually engages the sleeve (19) with, if required, continued admission of pressure fluid causing displacement of the sleeve (19) axially with respect to the block (7).

22. A system as claimed in claim 1, wherein the tubular body portion (22) is of extended length compared with an industry-standard sleeve, so that the piston (12) can be housed wholly within the sleeve (19).

23. A system as claimed in claim 1, wherein the tubular body portion (22) has two coaxial, internal bores (6B, 6C) separated by an annular, internal collar (23) of diameter corresponding to that of the piston (12), one bore (6B) being an outer bore adapted, in use, to releasably house a shank (4) of a mineral cutter pick (1), and the other bore (6C) being an inner bore to house the piston (12).

24. A system as claimed in claim 3, wherein the annular, internal collar (23) is provided with a sealing ring (24) slidably engageable with the external periphery of the portion of the piston (12) passing through the collar (23).

25. A system as claimed in claim 1, wherein the piston head (26) carries a sealing ring.

26. A system as claimed in claim 5, wherein an additional sealing ring (25), between the external periphery of the sleeve (19) and the internal periphery of the bore (6), is carried by a circumferential groove of the sleeve (19).

27. A system as claimed in claim 1, wherein the receiving bore (6) of the block (7) is extended such that the piston (12) is partially housed in the bore (6) of the block (7), and partially in the bore of the tubular body portion (22) of the sleeve (19).

28. A system as claimed in claim 7, wherein the sleeve (19) is stepped externally, and is provided with a first sealing ring adjacent its enlarged head (20), and a second sealing ring adjacent the end of the tubular body portion (22) distal from the enlarged head (20).

29. A system as claimed in claim 7, wherein the sleeve (19) is also stepped internally, as is the shank (4).

30. A system as claimed in claim 1, wherein the receiving bore (6) of the block (7) is a parallel sided through bore (6).

31. A system as claimed in claim 10, wherein the through bore (6) has an annular internal rib (30) at a rear end against which is abutted a bore closure disc (31) having a fluid flow bore (35) extending to an external nipple (36), for attachment of for example a manually operable grease type gun, at a time when hydraulic extraction is required, or as an alternative, a removable, screw-in, screw-out plug could be provided, the plug being removed for the attachment of a hydraulic hose fitting.
